(19) United States
(12) Patent Application Publication
(10) Pub. No.: US 2005/0073492 A1
(43) Pub. Date: Apr. 7, 2005

(54) Method of driving display device of field sequential driving mode

(76) Inventors: Dong-Jin Park, Dalseo-gu (KR); Tae-Hyeog Jung, Yangsan-si (KR); Hae-Jin Heo, Ulju-gun (KR)

Correspondence Address: Robert E. Bushnell;Suite 300, 1522 K Street, N.W., Washington, DC, 20005, US

(21) Appl. No.: 10/893,325

(22) Filed: Jul. 19, 2004

(30) Foreign Application Priority Data
Oct. 6, 2003 (KR) 2003-69310

(51) Int. Cl. G09G 3/36

(52) U.S. Cl. 345/89

(57) ABSTRACT

A method of driving a liquid crystal display device of a field sequential driving mode capable of realizing full color and obtaining a good contrast by optimizing the number of driving bits divides one frame into at least three sub-frames and displays first, second, and third color images for each sub-frame. One frame is driven with the number of driving bits satisfying at least one of two conditions satisfying conditions that at least one number of gray scales are realized for the liquid crystal display device and that the contrast ratio of the liquid crystal display device is at least another number. The optimal number of bits for driving one frame is in a predetermined range. The number of bits satisfying 16 gray scales for each of Red, Green, and Blue colors of the liquid crystal display device is at least 8, and the number of bits satisfying the condition that the contrast ratio of the liquid crystal display device is at least 100 is less than 16.

### CLAIM OF PRIORITY

This application makes reference to, incorporates the same herein, and claims all benefits accruing under 35 U.S.C. §119 from an application for LIQUID CRYSTAL DISPLAY DEVICE OF FIELD SEQUENTIAL DRIVING MODE earlier filed in the Korean Intellectual Property Office on 6 Oct., 2003 and there duly assigned Serial No. 2003-69310.

### BACKGROUND OF THE INVENTION

1. Field of the Invention

The present invention relates to a method of driving display device and, more particularly, to a method of driving display device of a field sequential driving mode, capable of implementing full color and obtaining a good contrast by optimizing the number of driving bits.

2. Description of the Related Art

In general, a color liquid crystal display device comprises a liquid crystal panel, having upper and lower substrates and liquid crystals interposed between the two substrates, a driving circuit driving the liquid crystal panel, and a backlight providing white light to the liquid crystals. This liquid crystal display devices can be classified into two modes, an RGB (red, green, blue) color filter mode and a color field sequential driving mode, according to a color image displaying method.

The liquid crystal display device for the color filter mode is configured in such a manner that R, G, B color filters are arranged to R, G, B unit pixels respectively into which one pixel is divided. In this configuration, light is transmitted from a backlight through the liquid crystals to the R, G, B color filters, and thus color images are displayed.

By contrast, the liquid crystal display device of the color field sequential driving mode is configured in such a manner that R, G, B backlights are all arranged to one pixel which is not divided into R, G, B unit pixels. In the configuration, three primary colors of light, R, G, B, from the R, G, B backlights are sequentially displayed through the liquid crystals in a time-shared manner, and thus color images are displayed using an after-image effect of the eye.

The field sequential driving mode, as compared with the color filter mode, has advantages in that it can implement a resolution almost three times higher than the color filter mode under the condition that the panels are of the same size, increase the light efficiency due to the absence of a color filter, and realize the same color reproduction as a color television and high-speed moving picture. In spite of these advantages, since one frame is divided into three sub-frames, the field sequential driving mode requires a driving frequency six times higher than that of the color filter driving mode. As such, high-speed operational characteristics are required for the field sequential driving mode.

Currently, in a liquid crystal display device of the digital field sequential driving mode, representation of the gray scale requires R, G, B data to be equal to or greater than a predetermined number of bits. If the bit number of R, G, B data is less than a predetermined number, it is difficult to realize full color. On the other hand, if the bit number of R, G, B data is not less than a predetermined number, the width of gate pulses is lower than a required range. For this reason, data signals can not be sufficiently transmitted for each pixel, which results in a deterioration of the image quality.

Therefore, it has been necessary to optimize the number of driving bits in the liquid crystal display device of the digital field sequential driving mode.

### SUMMARY OF THE INVENTION

Accordingly, the present invention is directed to solve the above-mentioned problems occurring in the prior art, and the objective of the present invention is to provide a method of driving display device of a field sequential driving mode capable of implementing full color and obtaining a good contrast by optimizing the number of driving bits.

In order to accomplish these and other objectives, the present invention provides a method of driving display device of a field sequential driving mode comprising: dividing one frame into at least three sub-frames; displaying first, second, and third color images, such as Red, Green, Blue, (R, G, B) images for each sub-frame on the liquid crystal display device; and driving one sub-frame with a number of driving bits satisfying at least one of two driving conditions satisfying conditions that: a contrast ratio of the liquid crystal display device is at least a first value, such as 100; and at least a second value of gray scales, such as 16 gray scales for the liquid crystal display device are realized.

Preferably, the number of driving bits satisfying the condition that the contrast ratio of the liquid crystal display device is at least 100 is less than 16.

Preferably, the number of bits capable of realizing at least 16 gray scales for the liquid crystal display device is a number of bits capable of realizing at least 16 gray scales for each of R, G, B colors of the liquid crystal display device.

Preferably, the number of bits capable of realizing at least 16 gray scales for each of the R, G, B colors is at least 8.

Preferably, a predetermined number of driving bits contain at least one reset bit adapted to improve a response time of liquid crystals of the liquid crystal display device.

Preferably, the at least one reset bit comprises at least 2 bits.

Preferably, the number of driving bits for driving one frame is in a range of 8 to 16 for each of the R, G, B colors of the liquid crystal display device.

In order to accomplish these and other objectives, the present invention provides a method of driving display device of a field sequential driving mode comprising: dividing one frame into at least three sub-frames; displaying Red, Green, Blue, (R, G, B) images for each sub-frame on the liquid crystal display device; and driving one sub-frame with a number of driving bits satisfying at least one of two driving conditions satisfying conditions that:
a contrast ratio of the liquid crystal display device is at least 100; and at least 4096 colors are realized for the liquid crystal display device.

Preferably, the number of driving bit satisfying the condition that the contrast ratio of the liquid crystal display device is at least 100 is less than 16.

Preferably, the number of bits capable of realizing at least 4096 colors for the liquid crystal display device is a number of bits that can realize at least 16 gray scales for each of R, G, B colors of the liquid crystal display device.

Preferably, the number of bits capable of realizing at least 4096 colors for each of R, G, B colors is at least 8.

Preferably, a predetermined number of driving bits contain at least one reset bit adapted to improve a response time of liquid crystals of the liquid crystal display device.

Preferably, the at least one reset bit comprises at least 2 bits.

Preferably, the number of driving bits for driving one frame is in a range of 8 to 16 for each of the R, G, B colors of the liquid crystal display device.

In order to accomplish these and other objectives, the present invention provides a method of driving display device of a field sequential driving mode comprising: dividing one frame into at least three sub-frames; displaying Red, Green, Blue, (R, G, B) images for each sub-frame on the liquid crystal display device; and driving one sub-frame with a number of driving bits for realizing at least a predetermined number of colors for the liquid crystal display device at a contrast ratio of the liquid crystal display device having at least a predetermined value.

Preferably, the number of driving bits is a number of bits for realizing at least 4096 colors for the liquid crystal display device at a contrast ratio of the liquid crystal display device of at least 100.

Preferably, the number of driving bits for driving one frame is in a range of 8 to 16 for each of the R, G, B colors for the liquid crystal display device.

Preferably, a predetermined number of driving bits contain at least one reset bit adapted to improve a response time of liquid crystals of the liquid crystal display device.

Preferably, the at least one reset bit comprises at least 2 bits.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 schematically illustrates a construction of a liquid crystal display device of a color field sequential driving mode; and

FIG. 2 shows a relationship between the number of representable gray scales, the number of representable colors and a contrast ratio based on the number of driving bits in a method of driving display device of a color field sequential driving mode according to an embodiment of the present invention.

### DETAILED DESCRIPTION OF THE PREFERRED EMBODIMENTS

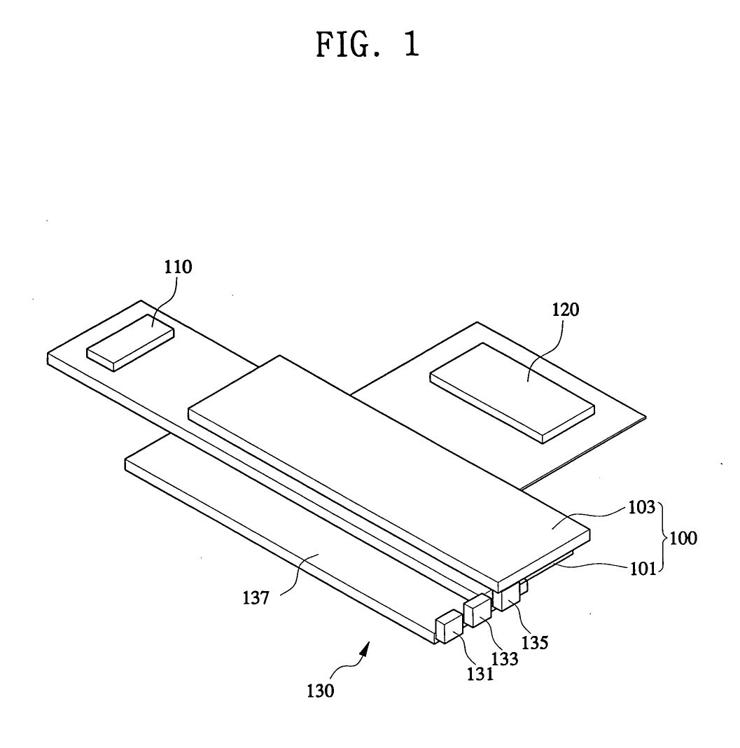

FIG. 1 schematically illustrates a configuration of a liquid crystal display device for a color field sequential driving mode.

Referring to FIG. 1, a liquid crystal display device includes a liquid crystal panel 100 composed of a lower substrate 101 on which an TFT array (not shown) is arranged with thin film transistors, for switching, connected to a plurality of gate lines, a plurality of data lines and a plurality of common lines, an upper substrate 103 on which a common electrode (not shown) is formed for providing common voltages to the common lines, and liquid crystals (not shown) injected between the lower and upper substrates 101 and 103.

Also, the liquid crystal display device further includes a gate line driving circuit 110 for providing scanning signals to the plurality of gate lines of the liquid crystal panel 100, a data line driving circuit 120 for providing R, G, B data signals to the data lines, and a backlight system 130 for providing three primary colors of light, R, G, B, to the liquid crystal panel 100.

The backlight system 130 is comprised of three R, G, B backlights 131, 133 and 135 for providing three primary colors of light, R, G, B, respectively, and a light guide plate 137 for providing R, G, B light emitted from the R, G, B backlights 131, 133 and 135 to liquid crystal of the liquid crystal panel 100.

Because the time interval of one frame generally driven at 60 Hz is 16.7 ms (1/60 sec), in the field sequential driving mode liquid crystal display device divided into three sub-frames from one frame as described above, one sub-frame has the time interval of 5.56 ms (1/180 sec). The time interval of one sub-frame is very short, thereby any field change cannot be visually recognized. Therefore, the human eye may recognize it with an added time of 16.7 ms, so that the combination of three primary colors, R, G, B, could be visually recognized.

The present invention will now be described more fully hereinafter with reference to the accompanying drawings, in which exemplary embodiments of the present invention are shown. The present invention may, however, be embodied in different forms and should not be construed as being limited to the embodiments set forth herein. Rather, these embodiments are provided so that this disclosure will be thorough and complete, and will fully convey the scope of the present invention to those skilled in the art. In the drawings, the thickness of layers and regions have been exaggerated for clarity. Like numbers refer to like elements throughout the specification.

A liquid crystal display device of a color field sequential driving mode according to an embodiment of the present invention has a structure as shown in FIG. 1. When the liquid crystal display device as set forth above is digitally driven to represent a gray scale, if the number of driving bits is too small, then it is not possible to represent a predetermined number of gray scales. Therefore, it is preferable to increase the number of driving bits as much as possible.

In order to represent a desired gray scale and thus to implement full color, it is necessary to increase the number of driving bits. However, if the number of driving bits increases, a driving frequency increases correspondently. If the driving frequency increases, a scanning signal or a gate pulse decreases in width, which is applied to a gate line of a liquid crystal panel 100 in a gate line driving circuit 110 shown in FIG. 1. Therefore, if the gate pulse having a very narrow width is applied to the corresponding gate line, a switching transistor is not sufficiently turned on. The data signals from the data line driving circuit 130 are then not sufficiently transmitted to a liquid crystal cell of the liquid crystal panel 100.

Furthermore, if the driving frequency increases, the display device undergoes deterioration of its characteristics. That is, if the driving frequency increases, it is possible to implement full color with the desired gray scale, but the contrast decreases in proportion to the increase of the driving frequency. The contrast represents the difference in brightness between the white state and the black state, and a contrast ratio refers to the ratio of the brightness in the white state to the brightness in the black state.

Typically, in order to display images in the display device, the contrast ratio must be 100 or more. That is, assuming that the brightness in the black state is 1, the brightness in the white state must be 100 or more.

Therefore, the present invention is focused on optimization of the number of driving bits so that it is possible to implement full color and obtain good operational characteristics in the display device.

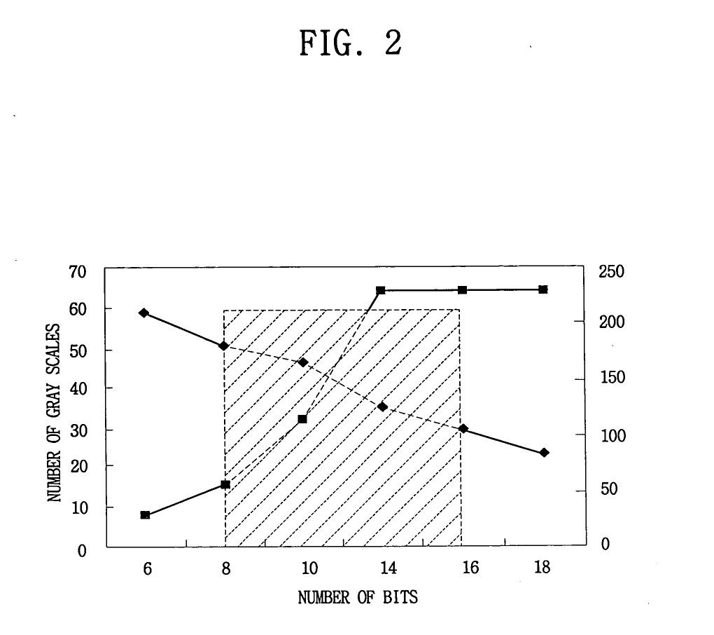

FIG. 2 shows a relationship between the number of representable gray scales, the number of representable colors and a contrast ratio based on the number of driving bits in a liquid crystal display device of a color field sequential driving mode according to an embodiment of the present invention. The squares represent gray scale values and the diamonds represent contrast values.

Referring to FIG. 2, in the case that the liquid crystal display device of the color field sequential driving mode is digitally driven, it can be appreciated that the number of representable gray scales and the number of representable colors increase according to an increase in the number of driving bits, but the contrast is deteriorated.

Table 1 shows the relationship of flicker and the contrast ratio against each driving bit number as shown in FIG. 2.

TABLE 1

| | | | | | | |
|---|---|---|---|---|---|---|
| Number of | 6 | 8 | 10 | 14 | 16 | 18 |
| driving bits | | | | | | |
| Number of | 8 | 16 | 32 | 64 | 64 | 64 |
| gray scales | | | | | | |
| Number of | 512 | 4096 | 32768 | 262144 | 262144 | 262144 |
| colors | | | | | | |
| Contrast ratio | 210 | 180 | 165 | 125 | 106 | 84 |

It can be seen from FIG. 2 and Table 1 that, in the present invention, the liquid crystal cells of the liquid crystal panel are driven by setting the number of bits satisfying two conditions such that 4096 or more colors are realized and that the contrast ratio is 100 or more as the number of driving bits which can digitally drive one frame. Accordingly, the liquid crystal panel is driven in the field sequential mode with the number of bits satisfying that the number of realizable gray scales is 16 for each of R, G, B colors and the number of realizable colors is 4096 or more, namely, the number of driving bits more than 8 bits.

Meanwhile, when the liquid crystal panel is driven with the number of driving bits less than 8 bits, it is possible to obtain the contrast ratio of 100 or more, but there is a problem that desired gray scale and color can not be represented. That is, when the panel is driven with 7 bits or less, it is theoretically possible to represent 16 gray scales for each of R, G, B colors. However, it is practically difficult to do so in the mobile display device due to combination of overlapped bits. Eventually, there is a problem that it is difficult to realize at least 4096 colors.

Therefore, according to the embodiment of the present invention, the number of driving bits is set to be more than 8 bits so as to represent 16 gray scales for each of R, G, B colors and thus to realize at least 4096 colors.

In the embodiment of the present invention, a predetermined number of the driving bits described above is allocated to a reset bit for improving the response time of the liquid crystals. In this case, it is necessary to allocate 2 bits or more to the reset bit.

Meanwhile, as the bit number of data increases, the contrast ratio is gradually reduced. In order to satisfy the contrast ratio of 100 or more required in the typical display device, it is preferable to set the number of driving bits to be less than 16 bits.

If the number of driving bits is set to be more than 18 bits, it may be possible to implement full color with 64 gray scales. However, because the contrast ratio is 84, namely, because the contrast ratio becomes less than 100, it is not possible to apply this to the typical display device.

Also, if the number of driving bits is set to be 18 bits, the width of the gate pulses is reduced, so that the driving data can not be properly provided to each pixel.

As stated above, in the present invention, the number of driving bits driving one frame is set to the range capable of representing 16 gray scales for each of R, G, B colors, and thus of realizing 4096 colors as well as obtaining the contrast ratio of 100 or more, that is, to the range from 8 bits to 16 bits for each of R, G, B colors, so that it is possible not only to implement full color but also to obtain the desired contrast ratio. As a result, a quality of image can be improved.

As set forth hereinabove, since the method of driving display device of the field sequential driving mode according to the embodiment of the present invention provides the optimized number of driving bits, it is possible to implement the full color and to obtain the desired contrast. Furthermore, it is possible to sufficiently provide a data voltage to each pixel by driving with a predetermined width of gate pulses, thereby preventing the deterioration of performance.

Although exemplary embodiments of the present invention has been described for illustrative purposes, those skilled in the art will appreciate that various variation and modifications are possible, without departing from the scope and spirit of the invention as disclosed in the accompanying claims.

1. A method of driving display device of a field sequential driving mode comprising:
dividing one frame into at least three sub-frames;
displaying first, second, and third color images for each sub-frame on the liquid crystal display device; and
driving one sub-frame with a number of driving bits satisfying at least one of two driving conditions satisfying conditions that:
a contrast ratio of the liquid crystal display device is at least 100; and
at least 16 gray scales equal to a second value for the liquid crystal display device are realized.

2. The method of driving display device according to claim 1, wherein the number of driving bits satisfying the condition that the contrast ratio of the liquid crystal display device is at least 100 is less than 16.

3. The method of driving display device according to claim 1, wherein the first, second, and third colors are respectively red, green, and blue.

4. The method of driving display device according to claim 3, wherein the number of driving bits satisfying the condition that the contrast ratio of the liquid crystal display device is at least 100 is less than 16.

5. The method of driving display device according of claim 1, wherein the number of bits capable of realizing at least 16 gray scales for the liquid crystal display device is a number of bits capable of realizing at least 16 gray scales for each of R, G, B colors of the liquid crystal display device.

6. The method of driving display device according to claim 5, wherein the number of bits capable of realizing at least 16 gray scales for each of the R, G, B colors is at least 8.

7. The method of driving display device according to claim 1, wherein a predetermined number of driving bits contain at least one reset bit adapted to improve a response time of liquid crystals of the liquid crystal display device.

8. The method of driving display device according to claim 7, wherein the at least one reset bit comprises at least 2 bits.

9. The method of driving display device according to claim 1, wherein the number of driving bits for driving one frame is in a range of 8 to 16 for each of the R, G, B colors of the liquid crystal display device.

10. A method of driving display device of a field sequential driving mode comprising:
dividing one frame into at least three sub-frames;
displaying Red, Green, Blue, (R, G, B) images for each sub-frame on the liquid crystal display device; and
driving one sub-frame with a number of driving bits satisfying at least one of two driving conditions satisfying conditions that:
a contrast ratio of the liquid crystal display device is at least 100; and
at least 4096 colors are realized for the liquid crystal display device.

11. The method of driving display device according to claim 10, wherein the number of driving bit satisfying the condition that the contrast ratio of the liquid crystal display device is at least 100 is less than 16.

12. The method of driving display device according to claim 10, wherein the number of bits capable of realizing at least 4096 colors for the liquid crystal display device is a number of bits that can realize at least 16 gray scales for each of R, G, B colors of the liquid crystal display device.

13. The method of driving display device according to claim 12, wherein the number of bits capable of realizing at least 4096 colors for each of R, G, B colors is at least 8.

14. The method of driving display device according to claim 10, wherein a predetermined number of driving bits contain at least one reset bit adapted to improve a response time of liquid crystals of the liquid crystal display device.

15. The method of driving display device according to claim 14, wherein the at least one reset bit comprises at least 2 bits.

16. The method of driving display device according to claim 10, wherein the number of driving bits for driving one frame is in a range of 8 to 16 for each of the R, G, B colors of the liquid crystal display device.
